(19) United States
(12) Patent Application Publication
(10) Pub. No.: US 2012/0137458 A1
(43) Pub. Date: Jun. 7, 2012

(54) Modular Pipeline Pig with Polymeric Spool Pieces

(76) Inventor: Kenneth M. Knapp, Houston, TX (US)

(21) Appl. No.: 12/959,762

(22) Filed: Dec. 3, 2010

(51) Int. Cl. B08B 9/04

(52) U.S. Cl. 15/104.061

(57) ABSTRACT

A modular pipeline pig is formed of one or more driving cups and one or more scrapers, all joined together by flexible polymeric spool pieces. The scrapers include notches or cut-outs along their peripheral edges to bypass fluid. The driving cups, scrapers, and flexible spool pieces are joined together by metal bolts, the only metallic part of the pig. A flow path is provided through and around the pig to flush paraffin away from the pig when it is resident within a receiver so that the pig can be easily removed from the receiver without the laborious manual removal of the paraffin.

### FIELD OF THE INVENTION

The present invention relates generally to the field of pipeline pigs, and, more particularly, to a modular pipeline pig with a plurality of spool pieces between multiple cups, scrapers, and the like, with the spool pieces formed of a polymeric material.

### BACKGROUND OF THE INVENTION

Materials in crude oil, particularly paraffin, tend to build up in pipelines carrying such crude oil. Some of the materials originate in water used in secondary recovery efforts, but materials other than crude oil and gas exist in the crude in its natural state, and over time, the build up of precipitants on the interior surfaces of pipes degrades performance of the flow of fluids through the pipeline.

When crude oil is pumped from the ground and transported through pipelines, a large heavy material separates and comes out of solution. The main component of this residue is high molecular weight paraffin wax. In some cases the wax represents as much as 90 percent of the deposited residues, and varies according to the origin of the crude oil.

Over the years, pipeline pigs have evolved to remove paraffin and other materials obstructing pipelines, and each step in the evolution of pigs has typically addressed a specifically identified need in the art. One need recognized in the art involves the removal of paraffin and other deposits in the 800-mile Trans Alaska Pipeline System (TAPS), which runs from Prudhoe Bay on the North Slope south to the Port of Valdez, the northernmost ice-free port in the United States. Alyeska operates the system for its owners. TAPS includes a number of features which present particular challenges to pigging operations. The system includes three pig launching and recovery facilities and these are located at pump stations 1 and 4 and at the marine terminal at Valdez, Ak. There a total of ten pump stations and one relief station. Along the route of the pipeline, a variety of valves are provided, including 81 check valves, 71 gate valves, 24 block valves and 1 ball valve for a total of 177 valves, each of which must be traversed by a pig in pigging the length of the system. The check valves of the system are particularly troublesome since they are heavy and may be jammed by extraneous materials from a damaged pig. Consequently, the pig must be rigid enough to span across the check valve to continue to transit the pipeline as it moves through the check valves.

On the other hand, TAPS includes many thermal expansion bends which demands that the pig be sufficiently flexible to continue to move around these bends without jamming in the pipe. This specification is almost the opposite of the specification for rigidity to traverse the valves of the system. Finally, the pig should be modular so that the length of the pig can be easily varied by the operator for different section of the pipeline or for different pipelines altogether.

The current art presents an even more intractable problem. As the pig approaches the receiving station, it has a huge quantity of paraffin wax built up in front of it. When the valve to the receiving station is opened to receive the pig in the receiver, often there is so much wax and other precipitant material present that the pig cannot even get into the receiver. Or, if the pig does make it into the receiver, it has so much paraffin wax built up around it that it cannot be removed from the receiver. This paraffin wax must be removed by hand, using specially designed tools, in an expeditious manner because another pig is coming along behind it in a few days time. Further, if the valve upstream of the receiving station leaks, then the workers laboring to remove the pig from the receiver may be exposed to many miles of hot crude oil flowing into the receiving station.

Thus, there remains a need for a pipeline pig that can move through the valves of a pipeline with sufficient rigidity to span the valve in transit. The pipeline pig should also be flexible enough to easily move through thermal expansion joints. The pig must offer some means of avoiding being stuck in the receiver due to an excess of buildup of paraffin wax and other materials. The present invention addresses these and other needs in the art.

### SUMMARY OF THE INVENTION

The present invention provides a modular pipeline pig formed of one or more driving cups and one or more scrapers, all joined together by flexible polymeric spool pieces. The scrapers include cut-outs along their peripheral edges to bypass fluid. The driving cups, scrapers, and flexible spool pieces are joined together by metal bolts, the only metallic part of the pig. The flexible spool pieces also include flow holes from the inside to the outside of the spool pieces and vice versa.

The pig may include a bulbous, parabolic nose, particularly adapted to forcefully contact a check valve in the TAPS and force the check valve open enough so that the pig clears the valve but allow the check valve to shut behind the pig. The nose may includes a plurality of flow holes to flush paraffin and other materials cleaned from the pipeline ahead of the pig. The pig also includes an arrangement of through-flow holes to develop and user selectable flow-by for oil to flush through and around the pig to remove paraffin was and other material build up through the receiver.

In another preferred embodiment of the invention, the pig does not include the bulbous nose, but uses a plain driving cup or scraper at the front end of the pig. Since the pig is assembled in a modular fashion, the pig may be assembled and arranged in the field as necessary by the operator. Furthermore, various components may be formed of materials of different hardness, to provide both flexibility and strength. Other types of components may also be included, such as brushes or other types of components known and to be developed in the field of pipeline pigs.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a side exploded view of a presently preferred embodiment of the pig of this invention.

FIG. 2 is a side view of the pig of FIG. 1 assembled.

FIG. 3 is a perspective view of the pig of FIG. 2.

FIG. 4 is an exploded perspective view of the pig.

### DETAILED DESCRIPTION OF PREFERRED EMBODIMENTS

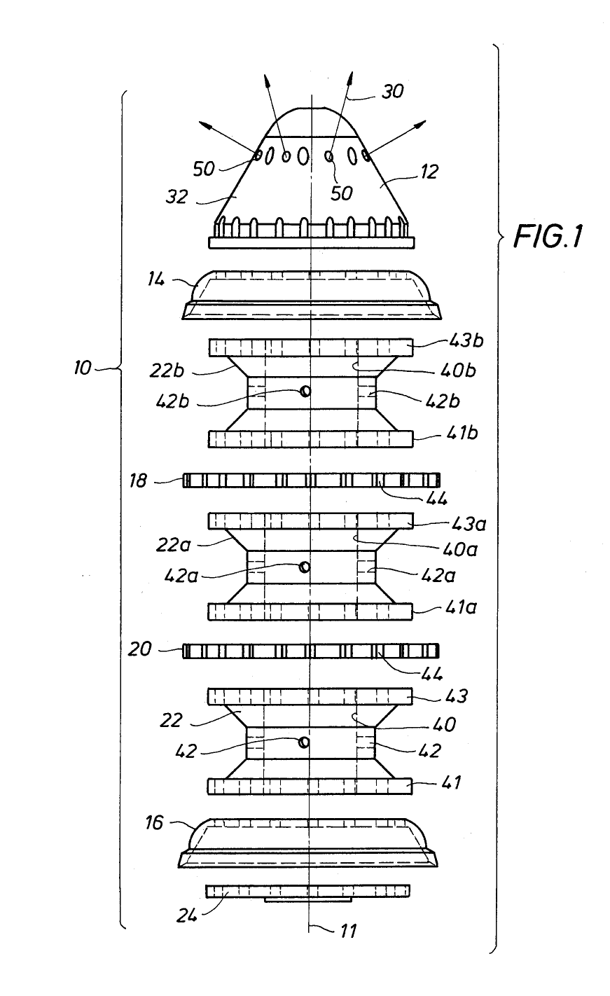

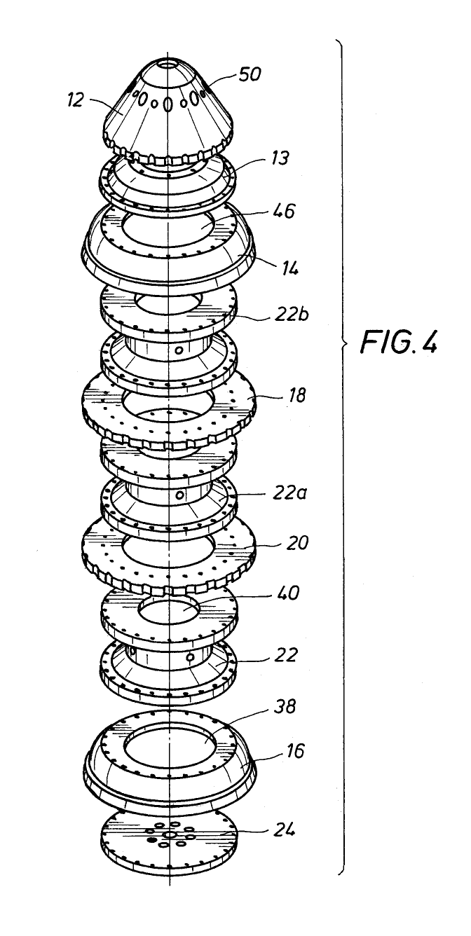

FIG. 1 depicts a side section view of a pig 10 comprising primarily a front nose 12 with a backing plate 13 (see FIG. 4), a front driving cup 14, a back driving cup 16, a front scraper 18, a back scraper 20, and a plurality of spool pieces or mandrels 22, 22a, and 22b joining the various cups and scrapers as shown. The assembly is completed with a base plate 24. Since the various components of the pig are assembled in modular form, more or fewer of the components may be used, as adapted for a particular application. The various components are preferably formed of a flexible, polymeric material, such as for example polyurethane. The various components are all arranged along an axis 11 of the pig, which is also the axis of the pipeline (not shown) through which the pig will operate.

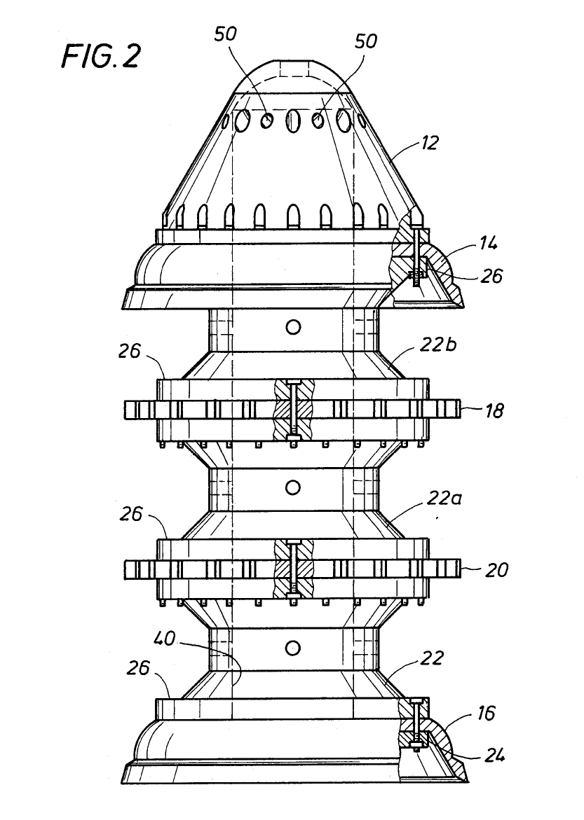

The nose, driving cups, scrapers, spool pieces, and base plate are held together with a plurality of bolts 26, as shown in FIG. 2 and described in greater detail below. The bolts 26 are the only parts of the pig that are made of metal; all other components are made of a polymeric material.

Note the preferred shape of the nose 12. The nose preferably comprises a parabolic leading point 30 and a contiguous conical section 32. This shape permits the nose to contact the check valves in TAPS and then slide by, without damaging the valve or the pig and without slamming the check valve back against its seat. This shape also provides a hydrodynamic shape for reduced resistance to movement of the pig. For other applications, a hemispherical nose or other shape may be used, if desired.

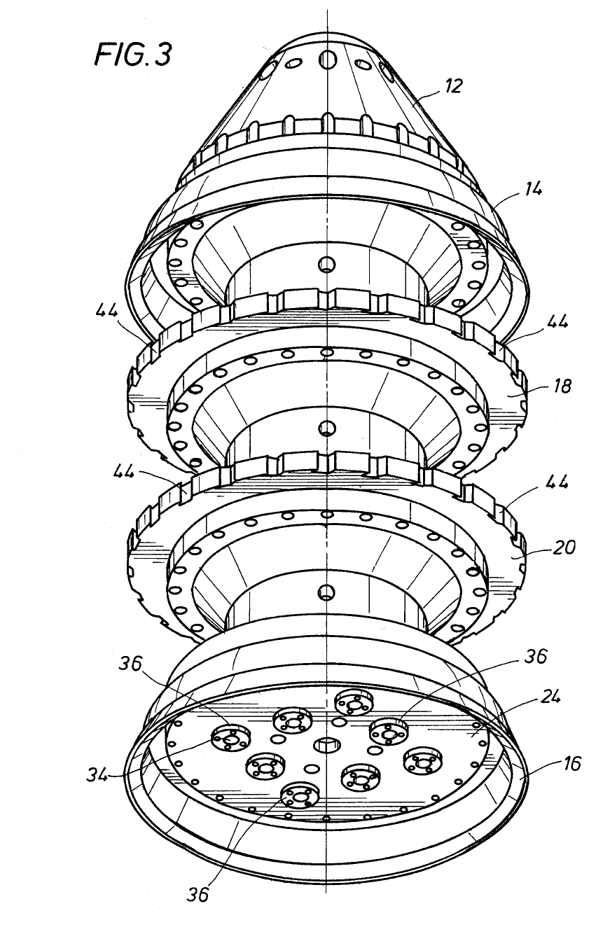

The pig also provides a path for driving oil to pass through and around the various components of the pig. The base plate 24 includes a plurality of holes 34, seen most clearly in FIGS. 3 and 4. The holes 34 are provided with inserts 36 to allow the user to determine the size of the opening through which oil will flow through the base plate. After flowing through the holes 34 with their inserts 36, the oil passes through a hole 38 in the back driving cup 16 (FIG. 4). The oil then flows into an axial, interior flow channel 40 in the rear-most spool piece 22. Thus, in a sense, the spool pieces are hollow. The spool piece 22 is also provided with a plurality of flow holes 42 from the flow channel 40 to the exterior of the pig. Note that the spool piece 40 includes an after flange 41 and a forward flange 43, the spool piece 40a includes an after flange 41a and a forward flange 43a, and the spool piece 40b includes an after flange 41b and a forward flange 43b.

While most of the oil continues to flow through the pig parallel to the axis 11, the by-pass flow which exited the pig through the flow holes 42 will continue forward, next encountering notches 44 arranged around the periphery of the back scraper 20. By permitting flow of oil through the notches 44 around the back scraper 20, oil and other materials are flushed forward by the pig, particularly when the pig arrives at a receiver, as described below.

The flow of oil continues in a similar fashion through the spool piece 22a, which includes flow holes 44a, and through the spool piece 22b, which includes the flow holes 44b. Flow of oil continues also around the edge of the forward scraper 18 through notches 44. The by-pass oil will finally encounter the forward drive cup 14 to push the pig forward. At this point, when the pig is stopped in the receiver, the hydrostatic pressure of the oil behind the forward drive cup 14 will exceed the pressure of the oil on the interior of the spool piece 22b, and oil will flow into the flow holes 42b. The oil will then flow through a hole 46 in the forward drive cup 14 and into the nose 12.

The nose 12 includes a plurality of flushing nozzles 50 which direct flushing oil outwardly at roughly a 45° angle. This flushing action keeps the front of the pig clear of obstructing paraffin and flushes the paraffin forward away from the pig when it is in the receiver.

It should now be clear that the pig of this invention is modular, in that it is assembled from a plurality of interchangeable parts. More scrapers and drive cups may be attached as required by a particular job, and other pig components may also be effectively used.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

1. A modular pipeline pig of user selectable length comprising:
a. at least two hollow axially oriented polymeric spool pieces, each of the two spool pieces having a forward flange and an after flange and a radially disposed hole therethrough;
b. a polymeric front drive cup mounted to the forward flange of a first of the at least two spool pieces;
c. a polymeric back drive cup mounted to the after flange of a second of the at least two spool pieces;
d. a polymeric scraper mounted between the at least two spool pieces; and
e. a polymeric nose mounted to the front drive cup.

2. The pig of claim 1, wherein the nose, the at least two spool pieces, the scraper, the front drive cup, and the back drive cup are bolted together.

3. The pig of claim 1, wherein each of the at least two spool pieces includes an interior flow channel parallel to the axis of the pig and an exterior, and further includes a plurality of flow holes from the flow channel through the spool piece to the exterior.

4. The pig of claim 1, wherein the scraper defines a periphery and further including a plurality of notches around the periphery for the flow of fluid through the notches.

5. The pig of claim 1, wherein the nose includes a plurality of flush holes therethrough.

6. The pig of claim 5, wherein the flush holes are directed at about a 45° angle.

7. The pig of claim 1, further comprising a base plate affixed to the back drive cup.

8. The pig of claim 7, further comprising a plurality of flow holes through the base plate parallel to the axis adapted for the flow of fluid through the pig.

9. The pig of claim 8, further comprising a user-selectable-sized insert in each of the plurality of flow holes through the base plate.

10. The pig of claim 1, wherein the nose comprises a parabolic section and a conical section contiguous with the parabolic section.

11. An axial modular pipeline pig comprising:
a. a polymeric nose comprising a ;
b. a polymeric front drive cup bolted behind the nose;
c. a first polymeric spool piece bolted behind the front drive cup;
d. a polymeric scraper bolted behind the first polymeric spool piece;
e. a second polymeric spool piece bolted behind the polymeric scraper; and
f. a polymeric back drive cup bolted behind the second spool piece.

12. The pig of claim 11, further comprising:
a back drive cup fluid flow channel through the back drive cup parallel to the axis into the second spool piece;
an axial second spool piece fluid flow channel through the second spool piece parallel to the axis and in fluid communication with the back drive cup fluid flow channel;
a plurality of radial second spool piece fluid flow channel from the axial second spool piece fluid flow channel to a region exterior of the pig;
a plurality of notches around the scraper;
a scraper fluid flow channel through the scraper in fluid communication with the axial second spool piece fluid flow channel;
an axial first spool piece fluid flow channel through the first spool piece parallel to the axis in fluid communication with the scraper fluid flow channel;
a plurality of radial first spool piece fluid flow channel from the axial first spool piece fluid flow channel to the region exterior of the pig;
a front drive cup fluid flow channel through the front drive cup parallel to the axis into the nose in fluid communication with the axial first spool piece fluid flow channel; and
a plurality of flush holes through the nose in fluid communication with the front drive cup fluid flow channel.
